(19) United States
(12) Patent Application Publication
(10) Pub. No.: US 2010/0134443 A1
(43) Pub. Date: Jun. 3, 2010

(54) Display device

(75) Inventor: Kenji Nakamura, Chiryu-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 12/588,734

(22) Filed: Oct. 27, 2009

(30) Foreign Application Priority Data
Dec. 1, 2008 (JP) 2008-306699

(51) Int. Cl. G06F 3/042

(52) U.S. Cl. 345/175

(57) ABSTRACT

A display device is disclosed. The display device includes a liquid crystal panel, a backlight, multiple light sensors and a touch location detection section. The backlight is controlled to be in an ON state and an OFF state in a predetermined duty ratio. Each light sensor detects intensity of ambient light incident on the liquid crystal panel, including a first intensity detected during a period of the ON state of the backlight and a second intensity detected during a period of the OFF state of the backlight. The touch location detection section detects a touch location on the liquid crystal panel based on location of one or ones of the multiple light sensors, the one or ones of the multiple light sensors being detecting the first and second intensities whose difference value exceeds a determination threshold.

### CROSS REFERENCE TO RELATED APPLICATION

The present application is based on Japanese Patent Application No. 2008-306699 filed on Dec. 1, 2008, disclosure of which is incorporated herein by reference.

### BACKGROUND OF THE INVENTION

1. Field of the Invention

The present invention relates to a display device capable of detecting a touch location on a liquid crystal panel.

2. Description of Related Art

JP-2007-248815A corresponding to US-2007/0216637A discloses a display device that includes a backlight and a liquid crystal panel having therein photo diodes, and that detects a touch location on the liquid crystal panel in the following ways.

When the liquid crystal panel is touched with an input pen in a bright condition such as during daytime and the like, the input pen shades ambient light. As a result, a shaded region is formed at the touch location on the liquid crystal panel, and a non-shaded region is formed at places other than the touch location. In such a case, an output current of a photo diode located at the shaded region becomes smaller than that of another photo diode located at the non-shaped region. Thus, it is possible to detect the touch location on the liquid crystal panel based on the location of the photo diode providing the small output current.

When the liquid crystal panel is touched with an input pen in a dark condition such as during nighttime and the like, the light radiated by the backlight is reflected from the input pen. As a result, an irradiated region is formed at the touch location on the liquid crystal panel and a non-irradiated region is formed at places other than the touch location. In such a case, an output current of a photo diode located at the irradiated region becomes larger than that of another photo diode located at the non-irradiated region. Thus, it is possible to detect the touch location on the liquid crystal panel based on the location of the photo diode providing the large output current.

The inventor of the present application has discovered that a conventional technique can bring the following difficulty. Since the above described conventional technique needs to change a method for detecting a touch location on a liquid crystal in accordance with environmental changes, it is difficult to use the conventional technique in an environment where ambient light greatly varies. For example, the conventional technique may not be suitable to an in-vehicle environment.

JP-2008-83465A discloses a technique in which the backlight is driven by duty control and the touch location is detected during an OFF state of the backlight. According to this technique however, it is difficult to detect a touch location on a liquid crystal panel in a dark condition because a dark condition such during nighttime and the like gives substantially no ambient light.

### SUMMARY OF THE INVENTION

In view of the above and other difficulties, it is an objective of the present invention to provide to a display device that is capable of detecting a touch location on a liquid crystal panel even in a situation where ambient light greatly varies.

According to an aspect of the present invention, there is provided a display device including a liquid crystal panel, a backlight, a backlight drive section, multiple light sensors and a touch location detection section. The liquid crystal panel has multiple pixels. The backlight is configured to irradiate the liquid crystal panel with light. The backlight drive section is configured to control the backlight so that the backlight is controlled to be in an ON state and an OFF state in a predetermined duty ratio. The multiple light sensors are arranged to provide a predetermined resolution of detection of touch location on the liquid crystal panel. Each light sensor is configured to detect intensity of ambient light incident on the liquid crystal panel. The intensity of ambient light detected during a period when the backlight is in the ON state is a first light intensity. The intensity of ambient light detected during a period when the backlight is in the OFF state is a second light intensity. The touch location detection section is configured to detect the touch location on the liquid crystal panel based on location of one or ones of the multiple light sensors, the one or ones of the multiple light sensors being detecting the first and second light intensities whose difference value exceeds a determination threshold.

According to the above display device, it becomes possible to detect a touch location on a liquid crystal panel even in an environment where ambient light greatly varies (e.g., in-vehicle environment).

### BRIEF DESCRIPTION OF THE DRAWINGS

The above and other objects, features and advantages of the present invention will become more apparent from the following detailed description made with reference to the accompanying drawings. In the drawings:

FIG. 1 is a diagram illustrating a display device according to one embodiment;

FIG. 2 is a flowchart illustrating a touch location detection procedure according to one embodiment;

FIG. 3A is a timing chart illustrating an ON state and an OFF state of a backlight in a bright condition;

FIG. 3B is a diagram illustrating a detection signal “B” obtained in the bright condition, the detection signal “B” being detected when the backlight is in the ON state;

FIG. 3C is a diagram illustrating a detection signal “C” obtained in the bright condition, the detection signal “C” being detected when the backlight is in the OFF state;

FIG. 3D is a diagram illustrating a subtraction signal “D” obtained by subtracting the detection signal “C” in FIG. 3C from the detection signal “B” in FIG. 3B;

FIG. 4A is a timing chart illustrating an ON state and an OFF state of a backlight in a dark condition;

FIG. 4B is a diagram illustrating a detection signal “B” obtained in the dark condition, the detection signal “B” being detected when the backlight is in the ON state;

FIG. 4C is a diagram illustrating a detection signal “C” obtained in the dark condition, the detection signal “C” being detected when the backlight is in the OFF state;

FIG. 4D is a diagram illustrating a subtraction signal “D” obtained by subtracting the detection signal “C” in FIG. 4C from the detection signal “B” in FIG. 4B;

FIG. 5 is a flowchart illustrating a touch location detection procedure according to one modification example; and

FIG. 6 is a graph illustrating corrected values of a substation signal “D”.

### DETAILED DESCRIPTION OF THE EXEMPLARY EMBODIMENTS

The exemplary embodiments are described below with reference to the accompany drawings.

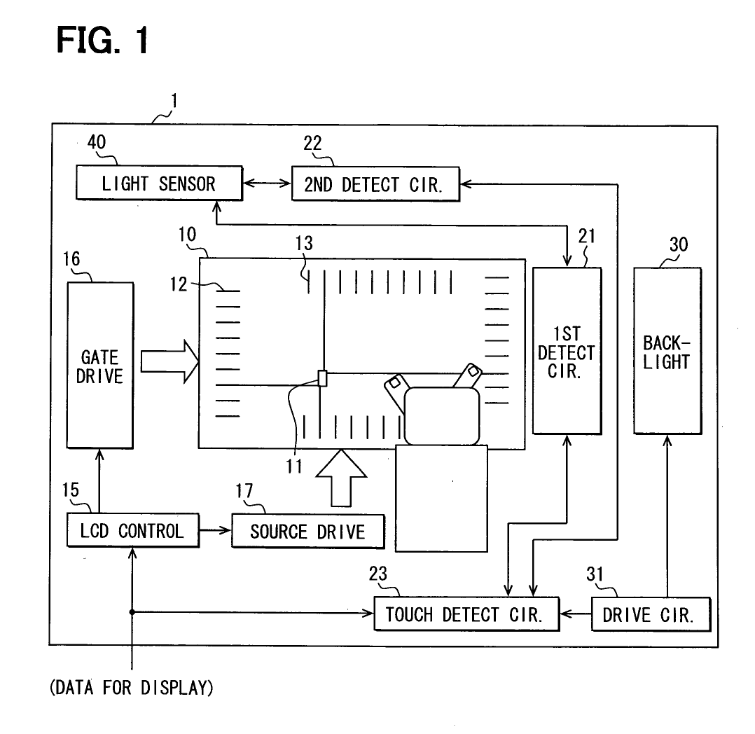

FIG. 1 is a diagram illustrating a display device 1 according to one embodiment. A configuration and a function of the display device 1 are described below with reference to FIG. 1.

As shown in FIG. 1, the display device 1 includes a liquid crystal panel 10. The liquid crystal panel 10 includes multiple pixels 11 arranged on the liquid crystal panel 10, multiple gate lines 12 connected with the multiple pixels 11, and multiple source lines 13 connected with the multiple pixels 11. Note that, for simplicity, a single pixel 11 is shown in FIG. 1.

The multiple gate lines 12 are arranged on the liquid crystal panel 10 at predetermined intervals. The multiple source lines 13 are arranged on the liquid crystal panel 10 at predetermined intervals so as to intersect the multiple gate lines 12. The multiple pixels 11 are respectively located at intersections of the multiple gate lines 12 and the multiple source lines 13.

Each pixel 11 includes the following components (not shown): a pixel transistor functioning as a switching element; a pixel electrode; a common electrode opposed to the pixel electrode; and a liquid crystal disposed between the pixel electrode and the common electrode. A gate electrode of the pixel transistor is connected with the gate line 12, and a source electrode of the pixel transistor is connected with the source line 13. A drain electrode of the pixel transistor is connected with the pixel electrode.

Suppose that a selection voltage is applied to the gate electrode of the pixel transistor via the gate line 12. When the selection voltage is applied, the pixel transistor switches in an ON state, and the source line 13 and the pixel electrode are conductively connected to each other. In the other words, the pixel is selected. When the pixel is selected and when a drive voltage is applied via the source line 13, the drive voltage is applied to the liquid crystal disposed between the pixel electrode and the common electrode. In accordance with the applied drive voltage, orientation and alignment order of the liquid crystal are changed. As a result, an amount of the light (with which the liquid crystal panel 10 is irradiated by the backlight 30) that the liquid crystal transmits is changed. A LCD (liquid crystal display) controller 15 included in the display device 1 controls the orientation of the liquid crystal so that, as the larger luminance of the pixel 11 is indicated by the data “A” for display, the amount of the transmitted light is larger. In other words, the LCD controller 15 controls the orientation of the liquid crystal so that, as the smaller luminance of the pixel 11 is indicated by the data “A” for display, the amount of the transmitted light is smaller.

The display device 1 further includes a gate driver 16 and a source driver 17 in addition to the liquid crystal panel 10 and the LCD controller 15. The LCD controller 15 can be connected to an external apparatus, which is external with respect to the subject display device 1. From the external apparatus, the LCD controller 15 obtains the data for display on the liquid crystal panel 10. When the LCD controller 15 receives the data for display, the LCD controller 15 determines the pixels 11 that should be selected for displaying the data for display, and applies the selection voltage to the gate line 12 via the gate driver 16. When the selection voltage is applied, the pixel 11 to be selected is selected. Further, the LCD controller 15 applies the drive voltage to the source line 13 via the source driver 17. When the drive voltage is applied, the orientation of the liquid crystal of the selected pixel 11 is controlled, and the amount of light (with which the liquid crystal panel 10 is irradiated by the backlight 30) passing through the liquid crystal is controlled. Through the above manners, the data for display is displayed on the liquid crystal panel 10. One embodiment can employ a known configuration and a known operation for displaying data on a liquid crystal panel 10.

The display device 1 further includes multiple light sensors 40, a first detection circuit 21, a second detection circuit 22, and a touch location detection circuit 23.

Each of the multiple light sensors 40 can detect intensity of ambient light incident on the liquid crystal panel 10. In one embodiment, a photo diode 40 capable of converting the ambient light into an electric signal is used as the light sensor 40. The multiple photo diodes 40 may be respectively built in the multiple pixels 11 and each photo diode 40 may output a larger electric current when the intensity of light received is larger. Alternatively, the multiple photos diodes 40 may not respectively be built in the multiple pixels 11 but may be built in some predetermined pixels 11 so that the multiple photo diodes 40 are arranged to have a density corresponding to resolution of detection of touch location on the liquid crystal panel. Alternatively, the multiple photo diodes 40 may not be built in but may be arranged to face the liquid crystal panel 10 and may be arranged to have a density corresponding to resolution of detection of touch location on the liquid crystal panel. The photo diode 40 can function as a light sensor.

The first detection circuit 21 includes a current-voltage conversion circuit and a shift register circuit. Electric currents outputted from the photo diodes 40 are converted into a voltage signal V1 having a serial signal form by the first detection circuit 21. In the above conversion, the photo diodes 40 outputting the electric currents may be ones of the multiple photo diodes 40 arranged in a horizontal direction (i.e., X direction). The first detection circuit 21 outputs the voltage signal V1 to the touch location detection circuit 23.

The second detection circuit 22 includes a current-voltage conversion circuit and a shift register circuit. Electric currents outputted from the photo diodes 40 are converted into a voltage signal V2 having a serial signal form by the second detection circuit 22. In the above conversion, the photo diodes 40 outputting the electric currents may be ones of the multiple photo diodes 40 arranged in a vertical direction (i.e., Y direction). The second detection circuit 22 outputs the voltage signal V2 to the touch location detection circuit 23.

One embodiment can employ known devices as the light sensor 40, the first detection circuit 21 and the second detection circuit 22.

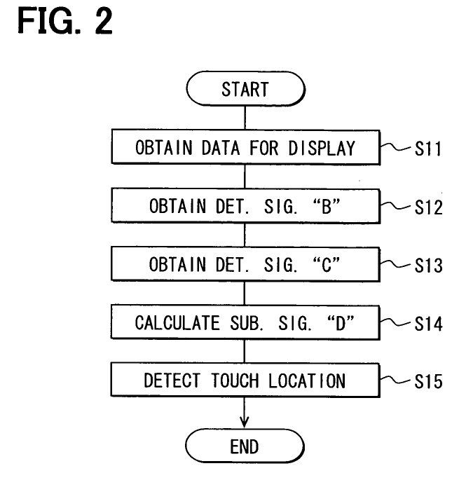

The touch location detection circuit 23 detects the touch location on the liquid crystal panel 10 based on the voltage signal V1 inputted from the first detection circuit 21 and the voltage signal V2 inputted from the second detection circuit 22. The touch location detection circuit 23 performs a touch location detection procedure, which will be later described with reference to FIGS. 2 to 4D. The touch location detection circuit 23 can function as a touch location detection section or means.

The display device 1 further includes a backlight 30 and a drive circuit 31. It should be noted that, although the backlight 30 is put rightward of the liquid crystal panel 10 in FIG. 1 in order to simplify FIG. 1, the backlight 30 may be actually arranged to face a back of the liquid crystal panel 10. The backlight 30 irradiates the liquid crystal panel 10 with light such that the light from the backlight 30 travels in a direction from the back to the front of the liquid crystal panel 10. The backlight 30 is connected with the drive circuit 31. The drive circuit 30 controls the backlight 30 so that the backlight 30 is in the ON state and the OFF state in a predetermined duty ratio. By this duty control, the intensity of the light outputted from the backlight 30 is controlled. The backlight 30 employed in one embodiment may be a duty-controllable lighting device such as a light emitting diode (LED), a fluorescent lamp, an electroluminescence device, or the like. The drive circuit 31 can function as a backlight drive section or means.

FIG. 2 is a flowchart illustrating a touch location detection procedure S1, which the display device 1 can perform. With reference to FIG. 2, there will be explained a touch detection procedure S1 performed by the touch location detection circuit 23 of the display device 1. The touch location detection procedure S1 is performed under a situation where the drive circuit 31 controls the backlight 30 so that the backlight 30 is turned on and off in the predetermined duty ratio and the backlight 30 irradiates the liquid crystal panel 10 with the light with the intensity corresponding to the predetermined duty ratio. Further, the touch location detection procedure S1 is cyclically performed at predetermined cycles.

When the display device 1 starts performing the touch location detection procedure S1, the touch location detection circuit 23 obtains at S11 the data “A” for display on the liquid crystal panel 10. More specifically, like the LCD controller 15 does, the touch location detection circuit 23 is connected with an external apparatus, which is external with respect to the display device 1, and the touch location detection circuit 23 obtains the data “A” for display from the external apparatus.

The light incident on the liquid crystal panel 10 from the backlight 30 can reflected from a finger of a user or the like. Thus, the intensity of light reflected from a finger of a user or the like can become larger as the larger luminance (bright) is indicated by the data. “A” for display, because the finger of a user or the like can reflect a larger amount of light. The intensity of the light reflected from a finger of a user or the like becomes smaller as the smaller luminance (dark) is indicated by the data “A” for display, because the finger of a user or the like cannot reflect the light. Thus, when receiving the data “A” for display, the touch location detection circuit 23 sets a determination threshold “Vth” to a larger value as the larger luminance is indicated by the data “A” for display. In other words, the determination threshold “Vth” is set to a smaller value as the smaller luminance is indicated by the data “A” for display. The touch location detection circuit 23 can function as a determination threshold setting section or means.

After the touch location detection circuit 23 obtains the display data “A” and sets the determination threshold “Vth”, the process proceeds to S12. At S12, the touch location detection circuit 23 obtains a detection signal “B” during a period when the backlight 30 is in an ON state, and obtains a detection signal “C” during a period when the backlight 30 is in an OFF state.

More specifically, the touch location detection circuit 23 is connected with the first detection circuit 21, the second, detection circuit 22 and the drive circuit 31. From the drive circuit 31, the touch location detection circuit 23 obtains information on a period when the backlight 30 is controlled to be in the ON state and a period when the backlight 30 is controlled to be in the OFF state. The touch location detection circuit 23 recognizes the period of the ON state of the backlight 30 and the period of the OFF state of the backlight 30. At S12, during the period of the ON state of the backlight 30, the touch location detection circuit 23 obtains the voltage signals V1 and V2 as the detection signal “B”. At S13, during the period of the OFF state of the backlight 30, the touch location detection circuit 23 obtains the voltage signals V1 and V2 as the detection signal “C”. The detection signal “B”, which is obtained during the period of the ON state of the backlight 30, can serve as a first light intensity. The detection signal “C”, which is obtained during the period of the OFF state of the backlight 30, can serve as a second light intensity.

After the touch location detection circuit 23 obtains the detection signal “B” and the detection signal “C”, the process proceeds to S14. At S14, the touch location detection circuit 23 subtracts the detection signal “C” from the detection signal “B”, thereby obtaining a subtraction signal “D”, which is also referred to as difference value “D”. More specifically, the touch location detection circuit 23 obtains the subtraction signal “D” by subtracting the voltage signal V1 obtained during the period of the OFF state of the backlight 30 from the voltage signal V1 obtained during the period of the ON state of the backlight 30, and by subtracting the voltage signal V2 obtained during the period of the OFF state of the backlight 30 from the voltage signal V2 obtained during the period of the ON state of the backlight 30.

After the touch location detection circuit 23 calculates the subtraction signal “D”, the process proceeds to S15. At S15, the touch location detection circuit 23 detects the touch location. More specifically, the touch location detection circuit 23 determines whether the subtraction signal “D” includes a value exceeding the determination threshold “Vth”. When it is determined that the subtraction signal “D” does not include a value exceeding the determination threshold “Vth”, the touch location detection circuit 23 determines that the liquid crystal panel 10 is not touched. When it is determined the subtraction signal “D” includes a value exceeding the determination threshold “Vth”, the touch location detection circuit 23 determines that the liquid crystal panel is touched at a place corresponding to one or ones of the multiple photo diodes 40 providing the value exceeding the determination threshold “Vth”.

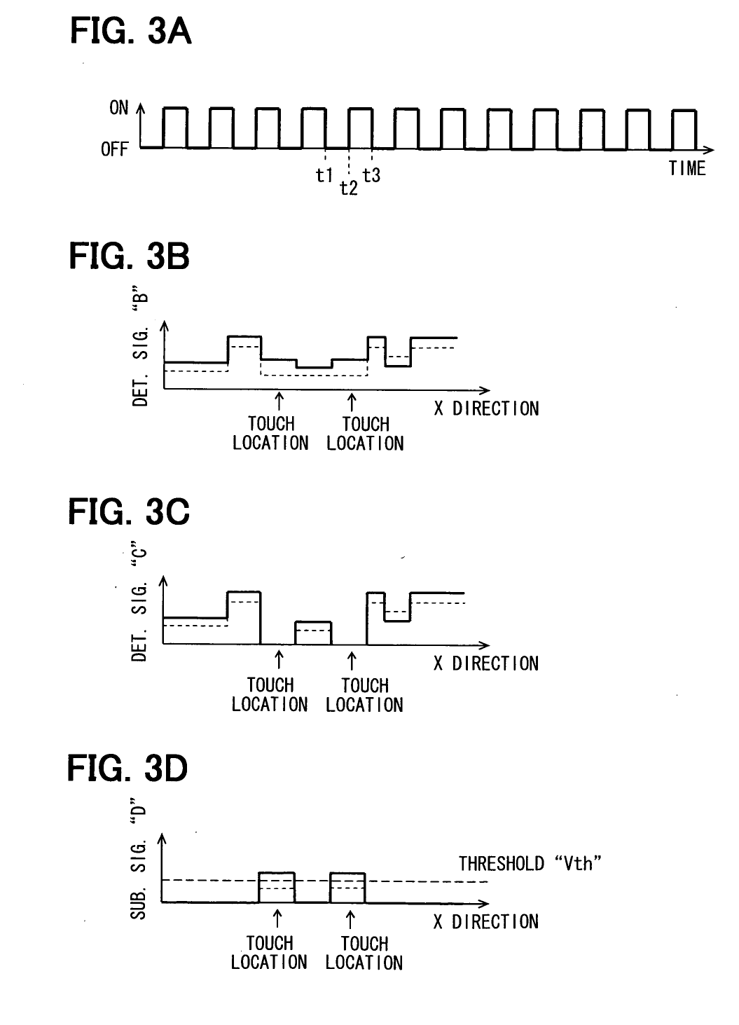

With reference to FIGS. 3A to 3D, there will be described operation of the display device 1 in a bright condition, which is during daytime for instance.

As shown in FIG. 3A, the drive circuit 31 controls the backlight 30 so that the backlight 30 is controlled to be in the ON state and the OFF state in the predetermined duty ratio.

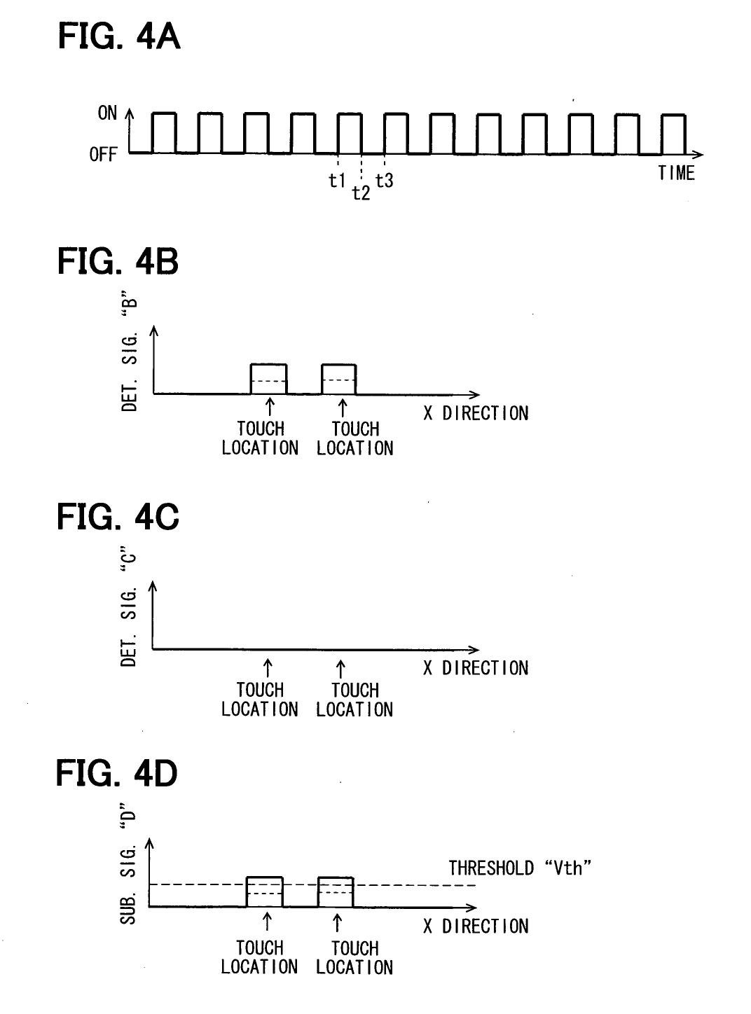

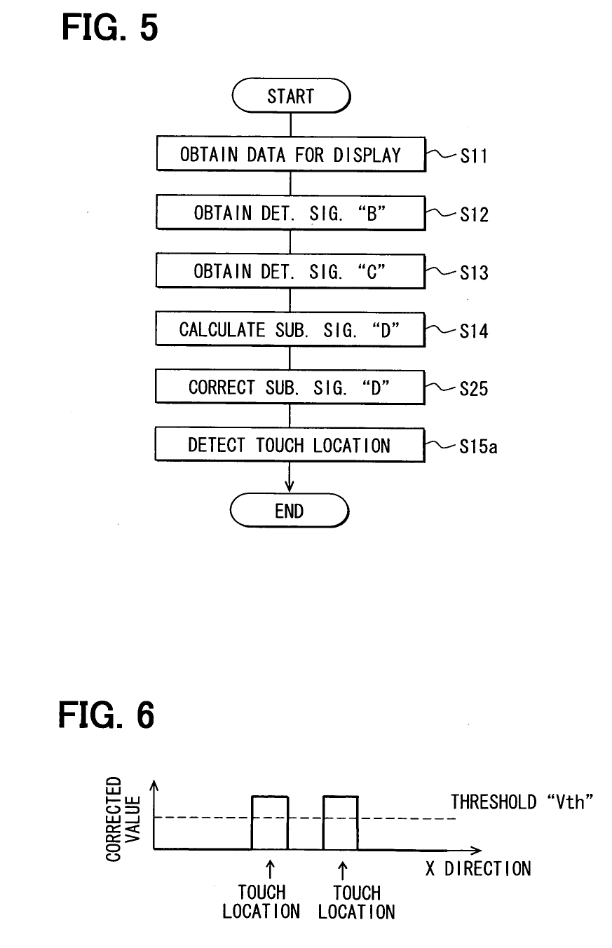

The touch location detection circuit 23 obtains the voltage signals V1 and V2 as the detection signal “C” during the period when the backlight 30 is in the OFF state. The period of the OFF state of the backlight 30 is, for example, between a time t1 and a time t2 (see FIG. 3A). FIG. 3C is a graph illustrating a part of the detection signal “C”, which is detected during the period of the OFF state of the backlight 30. The part of the detection signal “C” illustrated in FIG. 3C represents the voltage signal V1, values of which indicate the intensities of the light detected by the photo diodes 40 arranged in the X direction. In FIGS. 3B to 3D and FIGS. 4B to 4D, the solid line corresponds to a case where the large luminance (bright) is indicated by the data “A” for display, and the dashed line corresponds to a case where the small luminance is indicated by the data “A” for display.

The photo diode 40 located at a place where the liquid crystal panel 10 is not being touched can receive ambient light and can output an electric current with magnitude related to the received ambient light. The photo diode 40 located at a place where the liquid crystal panel 10 is being touched cannot receive the ambient light and cannot output an electric current substantially. As a result, as shown in FIG. 3C, the level related to the intensity of the ambient light is provided with a part of the detection signal “C”, the part corresponding to the un-touched places of the liquid crystal panel 10. The zero level is provided with another part of the detection signal “C” that corresponds to the touched place of the liquid crystal panel 10.

The touch location detection circuit 23 obtains the voltage signals V1 and V2 as the detection signal “B” during the period when the backlight 30 is in the ON state. The period of the ON state of the backlight 30 is, for example, between a time t2 and a time t3 (see FIG. 3A). FIG. 3B is a graph illustrating a part of the detection signal “B”, which is detected when the backlight 30 is in the OFF state. The part of the detection signal “B” illustrated in FIG. 3B represents the voltage signal V1, values of which indicate the intensities of the light that detected by the photo diodes 40 arranged in the X direction.

The photo diode 40 located at the untouched place of the liquid crystal panel 10 can receive ambient light and output an electric current with magnitude related to the received ambient light. Another photo diode 40 located at the touched place can receive the light that is outputted from the backlight 30 and reflected from a finger of a user or the like, and thus can output an electric current with magnitude related to the intensity of the reflected light. As a result, as shown in FIG. 3B, the level related to the intensity of the ambient light is provided with a part of the detection signal “B”, the part corresponding to the untouched places of the liquid crystal panel 10. The level related to the intensity of the reflected light is provided with another part of the detection signal “C” that corresponds to the touched place of the liquid crystal panel 10.

FIG. 3D is a graph illustrating a subtraction signal “D” which is obtained by subtracting the detection signal “C” illustrated in FIG. 3C from the detection signal “B” illustrated in FIG. 3B. Values of the subtraction signal “D” along the horizontal axis of FIG. 3D respectively correspond to the photo diodes arranged in the X direction. As described above, the level related to the intensity of the ambient light is provided with both of a part of the detection signal “B” and that of the detection signal “C”, the part corresponding to the untouched places of the liquid crystal panel 10. Thus, as shown in FIG. 3D, the zero value is provided with a part of the subtraction signal “D”, the part corresponding to the untouched places of the liquid crystal panel 10. Further, as described above, the level related to the intensity of the reflected light is provided with another part of the detection signal “B” that corresponds to the touched place of the liquid crystal panel 10. Further, the zero level is provided with another part of the detection signal “C” that corresponds to the touched place of the liquid crystal panel 10. Thus, as shown in FIG. 3D, the value related to the intensity of the reflected light is provided with another part of the subtraction signal “D” that corresponds to the touched place. It is therefore possible to detect the touch location on the liquid crystal panel 10 by determining whether the subtraction signal “D” includes a value exceeding the predetermined determination threshold “Vth”, because the touch location corresponds to the location of the photo diode 40 providing the subtraction signal “D” with the value exceeding the predetermined determination threshold “Vth”.

With reference to FIGS. 4A to 4D, there will be described operation of the display device 1 in a dark condition, which is during nighttime for instance.

As shown in FIG. 4A, the drive circuit 31 controls the backlight 30 so that the backlight 30 is controlled to be in the ON state and the OFF state in the predetermined duty ratio.

The touch location detection circuit 23 obtains the voltage signals V1 and V2 as the detection signal “C” during the period of the OFF state of the backlight 30. The period of the backlight 30 being in the OFF state is, for example, between a time t1 and a time t2 (see FIG. 4A). FIG. 4C is a graph illustrating a part of the detection signal C, which is detected during the period of the OFF state of the backlight 30. The part of the detection signal “C” illustrated in FIG. 4C represents the voltage signal V1, values of which indicate the intensities of the light detected by the photo diodes 40 arranged in the X direction.

The photo diode 40 located at the untouched place of the liquid crystal panel 10 is capable of receiving ambient light and outputting an electric current with magnitude related to the received ambient light. However, because of the dark condition, the photo diode 40 cannot receive the ambient light and thus outputs the electric current with zero magnitude. The photo diode 40 located at the touched place of the liquid crystal panel 10 also cannot receive the ambient light and thus outputs the electric current with zero magnitude. As a result, as shown in FIG. 4C, the zero level is provided with the detection signal “C” regardless of whether a part of the detection signal “C” corresponds to the untouched place or the touched place of the liquid crystal panel 10.

The touch location detection circuit 23 obtains the voltage signals V1 and V2 as the detection signal “B” during the period of the ON state of the backlight 30. The period of the backlight 30 being in the ON state is, for example, between a time t2 and a time t3 (see FIG. 4A). FIG. 4B is a graph illustrating a part of the detection signal “B”, which is detected during the period of the ON state of the backlight 30. The part of the detection signal “B” illustrated in FIG. 4B represents the voltage signal V1, values of which indicate the intensities of the light detected by the photo diodes 40 arranged in the X direction.

The photo diode 40 located at the untouched place of the liquid crystal panel 10 is capable of receiving ambient light and outputting an electric current with magnitude related to the received ambient light. However, because of the dark condition (e.g., nighttime), the photo diode 40 located at the untouched place cannot receive the ambient light and thus outputs the electric current with zero magnitude. The photo diode 40 located at the touched place of liquid crystal panel 10 can receive the light that is outputted from the backlight 30 and reflected from a finger of a user or the like. The photo diode located at the touched place outputs an electric current with magnitude related to the intensity of the reflected light. As a result, as shown in FIG. 4B, the zero level is provided with a part of the detection signal “B”, the part corresponding to the untouched place of the liquid crystal panel 10. The level related to the intensity of the reflected light is provided with another part of the detection signal “C” that corresponds to the touched place.

FIG. 4D is a graph illustrating a subtraction signal “D”, which is obtained by subtracting the detection signal “C” illustrated in FIG. 4C from the detection signal “B” illustrated in FIG. 4B. Values of the subtraction signal “D” along the horizontal axis of FIG. 4D respectively correspond to the photo diodes arranged in the X direction. As described above, the level related to the intensity of the ambient light is provided with both of a part of the detection signal “B” and that of the detection signal “C”, the part corresponding to the untouched places of the liquid crystal panel 10. Thus, as shown in FIG. 4D, the zero value is provided with a part of the subtraction signal “D” that corresponds to the untouched place of the liquid crystal panel 10. Further, as described above, the level related to the intensity of the reflected light is provided with another part of the detection signal “B” that corresponds to the touched place of the liquid crystal panel 10. Further, the zero level is provided with another part of the detection signal “C” that corresponds to the touched place. Thus, as shown in FIG. 4D, the value related to the intensity of the reflected light is provided with another part of the subtraction signal “D” that corresponds to the touched place. It is therefore possible to detect the touch location on the liquid crystal panel 10 by determining whether the subtraction signal “D” includes a value exceeding the predetermined determination threshold “Vth”, because the touch location corresponds to the location of the photo diode 40 providing the subtraction signal “D” with the value exceeding the predetermined determination threshold “Vth”.

Operation of the display device 1 of one embodiment can be described as follows. The touch location detection circuit 23 obtains the subtraction signal “D” by subtracting the detection signal “C”, which is detected during the period of the OFF state of the backlight 30, from the detection signal “B”, which is detected during the period of the ON state of the backlight 30. The touch location detection circuit 23 determines whether the subtraction signal “D” includes a value exceeding the determination threshold “Vth”. When it is determined that the subtraction signal “D” does not include a value exceeding the determination threshold “Vth”, the touch location detection circuit 23 determines that the liquid crystal panel 10 is not touched. When it is determined that the subtraction signal “D” includes a value exceeding the determination threshold “Vth”, the touch location detection circuit 23 determines that the liquid crystal panel 10 is touched. The above configuration provides the display device with an unpredictable advantage. The unpredictable advantage is, for example, that, independently from ambient light conditions, the display device 1 can detect a touch location on the liquid crystal panel 10 in one and the same manner. Therefore, the display device 1 can detect a touch location on the liquid crystal panel 10 even in a situation where the ambient light greatly varies. Such a situation is an in-vehicle environment for instance.

The above embodiment can be modified in various ways.

In the above embodiment, the touch location detection circuit 23 detects the touch location on the liquid crystal panel by specifying the location of the photo diode 40 providing a value exceeding the determination threshold “Vth” that is set based on the data “A” for display.

As described above, the intensity of the reflected light, which is incident on the liquid crystal panel 10 from the backlight 10 and is then reflected from an object, becomes larger as the larger luminance is indicated by the data “A” for display. In other words, the intensity of the reflected light becomes smaller as the smaller luminance is indicated by the data “A” for display. Thus, as shown by the solid lines and the dashed lines in FIGS. 3D and 4D, the difference value “D” becomes larger as the larger luminance is indicated by the data “A” for display. In other words, the difference value “D” becomes smaller as the smaller luminance is indicated by the data “A” for display.

The determination threshold “Vth” for the difference value “D”, which is changeable in accordance with the luminance indicated by the data “A” for display, may be set to a fixed value. However, the use of the fixed value may bring a case where the difference value “D” may not have a value exceeding the determination threshold “Vth” even if the liquid crystal panel 10 is touched. The above case may appear particularly when the luminance indicated by the data “A” for display is small. There is a possibility that detection accuracy of touch location on the liquid crystal panel 10 is reduced.

In view of the above, the touch location detection circuit 23 may perform a touch location detection procedure S1a as a modification of the touch location detection procedure S1. More specifically, at S25, the touch location detection circuit 23 corrects the difference value “D” by multiplying the difference value “D” by a predetermined correction factor, which is set to a larger value as the smaller luminance is indicated by the data “A” for display. By this correction, a small value in the difference values “D” (e.g., a value corresponding to a touch location in a case of the small luminance) is corrected and changed into a larger value. A large value in the difference values “D” (e.g., a value corresponding to a touch location in a case of the large luminance) is corrected and changed into a small value. A zero value in the difference values “D” is unchanged. Thus, as shown in FIG. 6, the difference values “D” illustrated in FIG. 3D or FIG. 4D can be changed into the same value at the touch location, regardless of whether the large or small luminance is indicated by the data “A” for display. Then, the touch location detection circuit 23 may detect at S15a the touch location based on the corrected value. The touch location detection circuit 23 performing S25 and S15a can act as a difference value correction section or means.

In the above, the touch location detection circuit 23 may correct the difference value “D” by multiplying the difference value by a predetermined correction factor, which is set to a smaller value as the larger luminance is indicated by the data “A” for display. Alternatively, the touch location detection circuit 23 may correct the difference value “D” by dividing the difference value by a predetermined correction factor, which is set to a larger value as the larger luminance is indicated by the data “A” for display. Alternatively, it is possible to use another correction manner that allows a predetermined determined threshold “Vth” to have a fixed value regardless of the luminance indicated by the data “A” for display.

While the invention has been described above with reference to various embodiments thereof, it is to be understood that the invention is not limited to the above described embodiments and constructions. The invention is intended to cover various modifications and equivalent arrangements. In addition, while the various combinations and configurations described above are contemplated as embodying the invention, other combinations and configurations, including more, less or only a single element, are also contemplated as being within the scope of embodiments.

Further, each or any combination of procedures, processes, steps, or means explained in the above can be achieved as a software section or unit (e.g., subroutine) and/or a hardware section or unit (e.g., circuit or integrated circuit), including or not including a function of a related device; furthermore, the hardware section or unit can be constructed inside of a microcomputer.

Furthermore, the software section or unit or any combinations of multiple software sections or units can be included in a software program, which can be contained in a computer-readable storage media or can be downloaded and installed in a computer via a communications network.

What is claimed is:

1. A display device comprising:
a liquid crystal panel having a plurality of pixels;
a backlight configured to irradiate the liquid crystal panel with light;
a backlight drive section configured to control the backlight so that the backlight is controlled to be in an ON state and an OFF state in a predetermined duty ratio;
a plurality of light sensors,
wherein the light sensors are arranged to face the liquid crystal panel and arranged to have a density corresponding to a predetermined resolution of detection of touch location on the liquid crystal panel,
wherein each light sensor is configured to detect intensity of ambient light incident on the liquid crystal panel,
wherein the intensity of ambient light detected during a period when the backlight is in the ON state is a first light intensity,
wherein the intensity of ambient light detected during a period when the backlight is in the OFF state is a second light intensity; and
a touch location detection section configured to detect the touch location on the liquid crystal panel based on location of one or ones of the light sensors, the one or ones of the light sensors being detecting the first and second light intensities whose difference value exceeds a determination threshold.

2. The display device according to claim 1, further comprising:
a determination threshold setting section configured to set the determination threshold, such that the determination threshold is larger as luminance of data for display on the liquid crystal panel is larger.

3. The display device according to claim 1, further comprising:
the difference value correction section configured to correct the difference value, such that the corrected difference value becomes larger as luminance of data for display on the liquid crystal panel is smaller.

4. The display device according to claim 3, wherein:
the difference value correction section corrects the difference value by multiplying the difference value by a predetermined correction factor;
the difference value correction section sets the predetermined correction factor, such that the predetermined correction factor is larger as the luminance of data for display on the liquid crystal panel is smaller.

5. A display device comprising:
a liquid crystal panel having a plurality of pixels;
a backlight configured to irradiate the liquid crystal panel with light;
a backlight drive section configured to control the backlight so that the backlight is controlled to be in an ON state and an OFF state in a predetermined duty ratio;
a plurality of light sensors,
wherein the light sensors are located to provide a predetermined resolution of detection of touch location on the liquid crystal panel,
wherein each light sensor is configured to detect intensity of ambient light incident on the liquid crystal panel,
wherein the intensity of ambient light detected during a period when the backlight is in the ON state is a first light intensity,
wherein the intensity of ambient light detected during a period when the backlight is in the OFF state is a second light intensity; and
a touch location detection section configured to detect the touch location on the liquid crystal panel based on location of one or ones of the light sensors, the one or ones of the light sensors being detecting the first and second light intensities whose difference value exceeds a determination threshold.
